(19) United States
(12) Patent Application Publication
(10) Pub. No.: US 2002/0069088 A1
(43) Pub. Date: Jun. 6, 2002

(54) Methods of providing pharmaceuticals and pharmaceutical services

(76) Inventor: Brian F. Berg, Kettering, OH (US)

Correspondence Address: DINSMORE & SHOHL, LLP, 1900 CHEMED CENTER, 255 EAST FIFTH STREET, CINCINNATI, OH, 45202, US

(21) Appl. No.: 09/728,032

(22) Filed: Dec. 1, 2000

(51) Int. Cl. G06F 17/60

(52) U.S. Cl. 705/3

(57) ABSTRACT

Methods are provided to dispense pharmaceuticals and pharmaceutical services, wherein a pharmaceutical or ancillary device is received from a manufacturer when ordered by a covered entity on behalf of a patient. Further, an accounts receivable associated with the patient is acquired by the manufacturer or in connection with a manufacturer from the covered entity. Moreover, the pharmaceutical or ancillary device is provided to the patient.

Further, a method of dispensing patient prescriptions is provided, such that an identification, an accounts receivable, and a prescription associated with a patient of a covered entity are received by a manufacturer or in connection with a manufacturer. The prescription is ordered using the credit of the covered entity and dispensed to the patient.

Additionally, a method of transacting business with a covered entity, a pharmaceutical manufacturer, and a patient is provided, wherein a prescription is ordered from a manufacturer on behalf of a covered entity and for the benefit of a patient of the covered entity. Also, an account associated with the ordering of the prescription and the patient is acquired by the manufacturer or in connection with a manufacturer from the covered entity, and the delivery of the prescription to the patient is managed.

### FIELD OF THE INVENTION

The present invention relates generally to methods of providing pharmaceuticals and pharmaceutical services.

### BACKGROUND OF THE INVENTION

In an effort to assist many health service organizations who are financially struggling to maintain services and to provide services to the under insured and to the non insured, a number of administrative rules and laws have been enacted in recent years. For example, the Public Health Service's Act (PHS), was enacted to allow covered entities to acquire pharmaceutical or pharmaceutical services at or below a ceiling price determined by a statutory formula, when these pharmaceuticals or pharmaceutical services are acquired directly from the manufacturer by the covered entity.

The savings associated with acquiring pharmaceuticals or pharmaceutical services need not be passed on to the patient of a covered entity, rather, the covered entity may use the savings to expand coverage to more eligible patients, or the savings may be used to offset expenses associated with pharmaceutical delivery or dispensing.

Although covered entities are defined by statute, these entities may include, byway of example only, health plans, health care clearinghouses, health care providers, community and migrant health centers, hemophilia clinics, Ryan White HIV service programs (e.g. state AIDS drug assistance programs), and others. These entities have precious limited resources, which the government has determined are better focused on providing care to patients. As a result, legislation, such as PHS, permits covered entities to avoid wasting resources on developing in-house pharmacies, when these services are to be more efficiently contracted or acquired elsewhere by the covered entities.

Moreover, contract pharmacies are becoming more pervasive among covered entities. These contract pharmacies provide pharmaceuticals and pharmaceutical services to covered entities at prices below what it would cost a covered entity to maintain and run its own in-house pharmacy. Further, PHS permits contract pharmacies to acquire/manage pharmaceuticals or pharmaceutical services as agents of the covered entities at discounted prices. This has afforded covered entities the benefit of reduced pricing without the need to develop in-house pharmacies to take advantage of the discount pricing as dictated by laws such as PHS.

Yet, covered entities are still burdened substantially with maintaining inventories, records associated with the pharmaceuticals or pharmaceutical services, and collection of monies from the patient or the patient's insurance carrier to reimburse the covered entity for acquiring/managing the pharmaceuticals or pharmaceutical services. These administrative functions are not without significant expense to the covered entity, and as a result many of the benefits associated with PHS have not been fully realized by the covered entities. In fact, in some situations the proliferation of administrative staff to maintain a qualified PHS program has increased expenses for the covered entity.

It is readily apparent that a service, which can manage not only the ordering and/or delivering of the pharmaceuticals from the manufacturer and be the provider of any necessary pharmaceutical services is desirable, but also this service should be capable of managing records, inventories, and accounts receivables of the patients. In this way, covered entities may truly realize the cost savings that programs such as PHS were designed to provide, and these same covered entities may then use the savings to expand coverage to more patients, which was the goal of programs such as PHS. Further, limited health care resources may be focused by the covered entities on providing quality cost effective health care, rather than on administering paperwork associated with a program.

### SUMMARY OF THE INVENTION

Accordingly, an object of the invention is to provide covered entities with novel methods to dispense and manage the delivery of pharmaceuticals and pharmaceutical services.

By way of example only, consider a covered entity who has a patient desiring a pharmaceutical or pharmaceutical service and an accounts receivable which is associated with the patient. A physician provided prescription for the pharmaceutical or pharmaceutical service may be provided to a contract pharmacy who orders the pharmaceutical or pharmaceutical service from a manufacturer on behalf of the covered entity.

Moreover, the covered entity relinquishes (e.g. sells, transfers, and others) the accounts receivable associated with the patient to the contract pharmacy. The manufacturer provides a discounted price for the ordered pharmaceutical or pharmaceutical service, since the covered entity placed the order. Further, the manufacturer delivers the ordered pharmaceutical or pharmaceutical service to the contract pharmacy, wherein the delivery of the ordered pharmaceutical or pharmaceutical service is administered to the patient through the management of the contract pharmacy. The collection of a payment from a patient or a patient's insurance company to pay for the pharmaceutical or pharmaceutical service is managed by the contract pharmacy, successful collection of payment will satisfy a debit associated with the patient's accounts receivable. The debit resulted when the pharmaceutical or pharmaceutical service was received from the manufacturer. Moreover, upon receipt of the accounts receivable, the covered entity is compensated by the contract pharmacy. Although as one skilled in the art will readily appreciate, the debit could occur at any time and may occur after the pharmaceutical is received.

Additional objectives, advantages and novel features of the invention will be set forth in the description that follows and, in part, will become apparent to those skilled in the art upon examining or practicing the invention. The objects and advantages of the invention may be realized and obtained by means of the instrumentalities and combinations particularly pointed out in the appended claims. To achieve the foregoing and other objects and in accordance with the purpose of the present invention, methods are provided for providing pharmaceuticals and pharmaceutical services.

A method of providing pharmaceutical services is provided, comprising receiving a pharmaceutical or ancillary device resulting from an order received on behalf of a covered entity for the benefit of a patient. Moreover, an accounts receivable associated with the patient is acquired by a manufacturer or in connection with the manufacturer, and the pharmaceutical or ancillary device is provided to the patient.

Another aspect of the present invention provides a method of dispensing a patient's prescription, comprising receiving an identification associated with a patient of a covered entity and a prescription for the patient. Next, the prescription is ordered using the credit of the covered entity, and an accounts receivable associated with the patient is received by a manufacturer or in connection with a manufacturer from the covered entity. Also, the ordered prescription is dispensed to the patient.

Furthermore, a method of transacting business with a covered entity, a pharmaceutical manufacturer, and a patient is provided, comprising ordering a prescription from a pharmaceutical manufacturer on behalf of a covered entity, wherein the prescription is for a patient of the covered entity. Moreover, an account associated with the ordered prescription and the patient is acquired by the manufacturer or in connection with the manufacturer from the covered entity, and the delivery of the prescription to the patient is managed.

Still other aspects of the present invention will become apparent to those skilled in the art from the following description of a preferred embodiment, which is by way of illustration, one of the best modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 depicts a flow diagram of a method for providing pharmaceutical services;

FIG. 2 depicts a flow diagram of a method for providing patient prescriptions; and

FIG. 3 depicts a flow diagram of a method for transacting business with a covered entity, a pharmaceutical manufacturer, and a patient.

Reference will now be made to the present exemplary embodiment of the invention, an example of which is illustrated in the accompanying drawings, wherein like numerals indicate the same element throughout the views.

### DETAILED DESCRIPTION

An exemplary embodiment of the present invention is implemented using web browser technologies including software programming languages (e.g. C, C++, Java, Active X, Active Server Pages), Internet communication protocols (e.g. TCP/IP), and data formatting languages (e.g. XML, XSL, XSLT, HTML). However, other software programming languages, communication protocols, or data formats, now known or hereinafter developed may be used without departing from the present invention.

Consider by way of example only, a covered entity having an established relationship with a contract pharmacy, and further desiring to participate in a government program such as PHS, where pharmaceuticals, ancillary devices associated with pharmaceuticals, or pharmaceutical services may be acquired directly from a manufacturer at discounted price levels defined by statutory formula.

In the present example, the contract pharmacy manages the entire PHS program for the covered entity, including the acquisition or purchase of accounts receivable associated with payment for the pharmaceuticals, ancillary devices associated with the pharmaceuticals, and pharmaceutical services. Moreover, records and inventories associated with a patient participating in a PHS program are managed by the contract pharmacy The covered entity receives reports upon request, regarding any transactions and collections associated with the program.

In this way, the covered entity may receive payment when a patient participates in the PHS program, by providing (e.g. selling) to the contract pharmacy the patient's account receivable and the prescriptions desired by the patient. The prescriptions may include pharmaceuticals, ancillary devices associated with a pharmaceutical, or pharmaceutical services. Moreover, some patients with diseases such as hemophilia may require a variety of continuous pharmaceuticals to manage their Hemophilia.

A manufacturer, capable of supplying the prescription, is contacted on behalf of the covered entity to provide the medication directly to the contract pharmacy. Acquisition of the medication from the manufacturer may be done by way of a loan or credit associated with an account of the covered entity from the manufacturer. Further, the covered entity is compensated by the contract pharmacy or manufacturer for the patient acquired account in amount which may greater or as great as the loan or credit amount advanced by the manufacturer on behalf of the covered entity. Although, it should be readily apparent that the manufacture providing the medication need not be the same manufacturer who may acquire and compensate the covered entity for the account.

The contract pharmacy receives the prescription and delivers or dispenses it to the patient of the covered entity. Moreover, the contract pharmacy may provide additional services to the patient such as, by way of example only, pharmacist consultation, prescription interactions, prescription histories, and other services. Further, the contract pharmacy may verify the insurance of the patient and acquire payment from the insurance or directly from the patient to compensate the contract pharmacy for the prescription and other services rendered

Furthermore, the contract pharmacy may maintain and manage inventories for the covered entity and provide reports on those inventories on a customizable basis. Also, reports on the collect ability of the accounts receivables acquired by the contract pharmacy or manufacturer may be reported to the covered entity and used to project an appropriate price to be paid for any accounts receivables acquired at some point in the future by the contract pharmacy or manufacturer.

In this way, many excessively ministerial and administrative functions associated with implementing programs, such as PHS, are eliminated by the covered entity and payment for filling a prescription is immediately guaranteed providing the necessary cost savings and cash flow that many covered entities desperately need to stay profitable and to ensure stability in health care costs passed on to patients.

Although the example provided above discusses contract pharmacies and the PHS program, it is readily apparent to those skilled in the art that any organization, government program, or ad hoc developed program could be used without departing from the tenets of the present invention. Accordingly, the examples presented above and below are for purposes of illustration only and are not intended to limit the present invention.

For example, a web service business operating over the World Wide Web (WWW) may act as a logical contract pharmacy and receive information directly from a covered entity over a secure web site and perform all the methods discussed herein. The deployment of such a web service would be readily ascertainable and implemented by one skilled in the art.

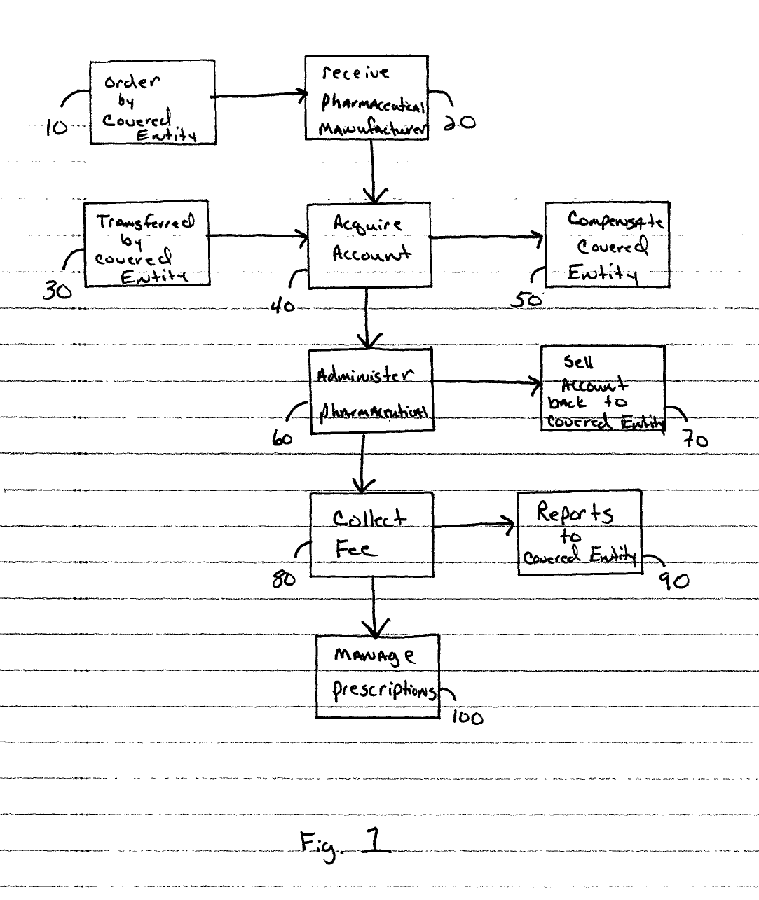

FIG. 1 depicts one method of a flow diagram for a method of providing pharmaceutical services. Initially a prescription may be received on behalf of a patient of a covered entity (not shown in FIG. 1). The prescription may include, pharmaceuticals, ancillary devices associated with pharmaceuticals, or pharmaceutical services. Moreover, the prescription may be from a covered entity's participating physician, or the prescription may be a standing order of a covered entity's physician (e.g. refill) for patients with chronic diseases, such as by way of example only Hemophilia.

Received prescriptions may then be ordered by the covered entity in step 10. Although, as is readily apparent, a service may order the prescription using the credit or on behalf of the covered entity, and the covered entity may not need to actually order the prescription. Orders are placed with manufacturers capable of supplying the medications for the prescriptions, and optimally participating in programs, such as by way of example only, PHS wherein the covered entity receives the medications associated with the prescriptions at predetermined discounted prices.

In step 20 the medication for the prescription is received from the manufacturer and in step 40 the covered entity transfers (step 30) an account associated with the prescription and the patient. The covered entity is compensated in step 50 for transferring the account. As previously presented, a price to acquire the account may greater than or at least as great as the price of the acquired prescription, although in some instances an account determined to be a collection risk may actually be acquired for less than the acquired medication price. Furthermore, historical data regarding accounts of FIG. 1 may be retained and analyzed using standard accounting projections and actuary techniques to determine price levels of future acquired accounts. In this way, an entity providing the services of FIG. 1 (e.g. contract pharmacy, manufacturer, automated web site, and others) and the covered entity may arrive at mutually acceptable pricing schedules for the acquisition of these accounts.

As will be apparent to one skilled in the art, compensation to the covered entity may occur at any appropriate point in time, during the method depicted by FIG. 1. Further, the actual sequence of steps in FIG. 1 may be altered without detracting in any way from the present invention.

In step 60, the prescription is administered to the patient. Administration may include delivering the prescription directly to the patient at a location defined by the patient (e.g. to the patient's home, a vacation location of the patient, and others), delivering the prescription to personnel associated with the covered entity for the benefit of the patient (e.g. registered nurses, physicians, certified technicians), and others. Once the prescription is administered, the service of FIG. 1 may collect a fee (step 80) associated with acquiring and administering the prescription on behalf of the covered entity. This fee maybe greater than the price paid to the covered entity to acquire the account. Collection may include billing an insurance associated with the patient or billing the patient directly. Moreover, in some instances collection may be acquired by selling the account of a patient back to the covered entity (step 70) or to a collection agency (not shown in FIG. 1).

Periodically, or on demand, customized reports may be generated and provided to the covered entity (step 90) regarding the service of FIG. 1. These reports may include, by way of example only, pharmaceutical inventories, uncollectible accounts, aged accounts, patient prescription activity, and others. Moreover, the prescriptions associated with a patient may be managed in step 100, such that drug interactions, prescription histories, and additional information may be provided to the patient on demand.

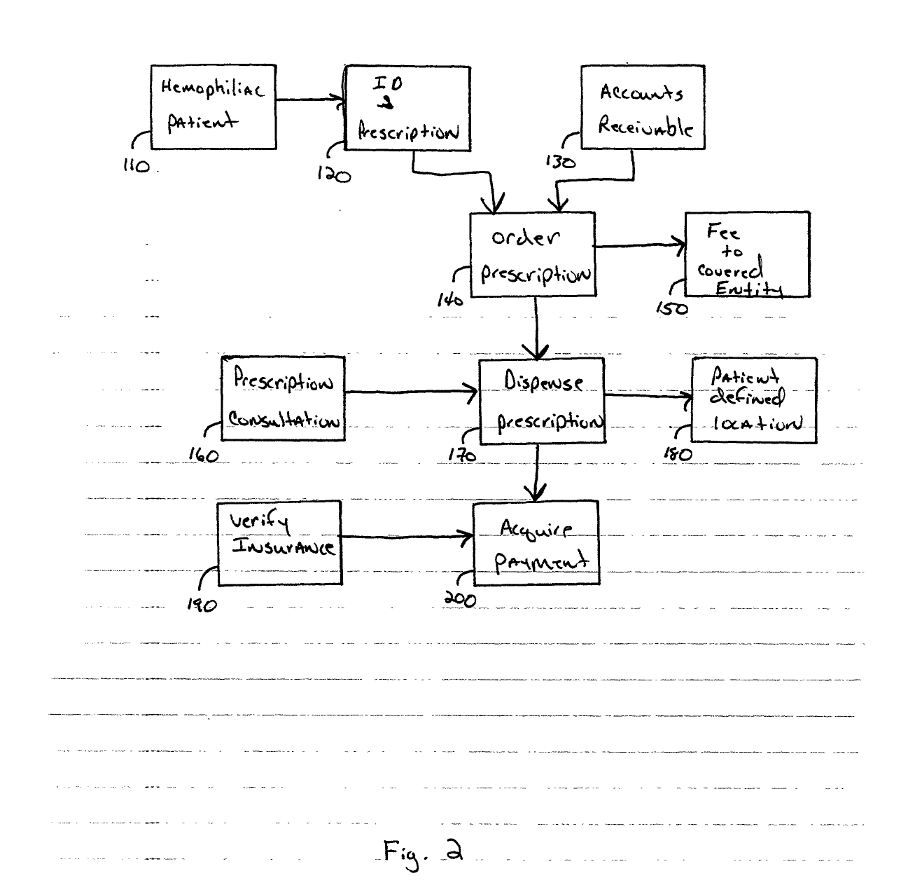

FIG. 2 depicts a flow diagram of one method for providing patient prescriptions, The method of FIG. 2 may be provided by any service (e.g. automated web site, contract pharmacy, manufacturer, and others). Initially, a covered entity provides an identification and a prescription (step 120) associated with a patient of the covered entity (e.g. a Hemophiliac, step 110). Further, an accounts receivable (step 130) associated with the patient is provided and debited upon the ordering of a patient prescription in step 140. Moreover, the covered entity receives a fee associated with providing the accounts receivable in step 150.

Once the prescription is filled by a manufacturer or supplier, the prescription may be dispensed to the patient in step 170. The physical location to deliver the prescription may be defined by the patient in step 180. Although, the covered entity may define the location to deliver the prescription as well. Further, pharmaceutical consultations may be provided in step 160.

Payment for the service of FIG. 2 is acquired in step 200, collection of payment may entail, by way of example only, verifying insurance of the patient in step 190, billing an insurance of the patient, billing the patient directly, selling the accounts receivable to a collection agency, selling the accounts receivable back to the covered entity, and others.

As one skilled in the art will readily appreciate, the method of FIG. 2 provides significant benefits to a service deploying the method of FIG. 2 as well as the covered entity associated with FIG. 2. The service may receive a discounted price associated with having medications being supplied from manufacturers, especially when these medications are supplied in compliance with programs such as PHS. Moreover, the covered entity alleviates itself from many administrative burdens associated with managing patient prescription and payment information, which will correspondingly substantially reduce expenses of the covered entity.

Moreover, the sequence of steps depicted in the method of FIG. 2 may be altered without detracting from the present invention. In fact, the steps may occur in any order with no dependencies whatsoever.

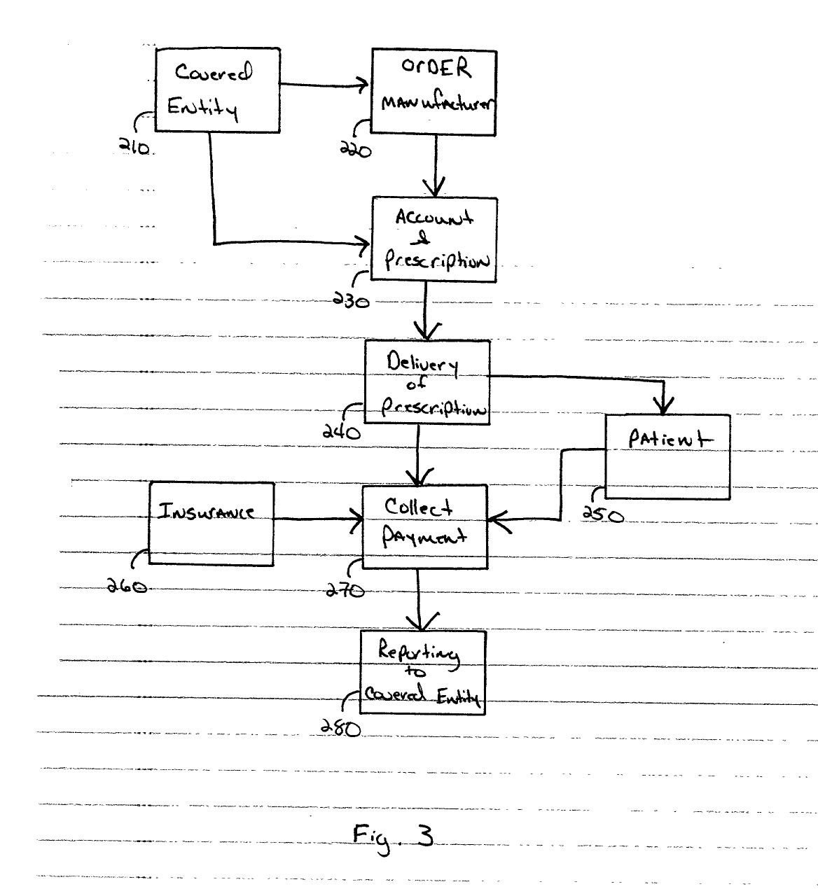

FIG. 3 depicts a flow diagram of one method for transacting business with a covered entity, a pharmaceutical manufacturer, and a patient. Again, the method of FIG. 3 may be readily adopted by automated services (e.g. web site, software applications, and others) or by entities (e.g. contract pharmacies, and others). The method of FIG. 3 interacts with three entities a covered entity, a manufacturer or supplier of medications, and a patient of the covered entity.

Initially, a covered entity is identified in step 210 and an order is placed to fill a prescription with a manufacturer in step 220. Further, an account and the prescription information are received from the covered entity in step 230, with delivery of the prescription occurring in step 240. Delivery or dispensing of the prescription is made on behalf of a patient in step 250.

Next, payment is collected in step 270 for providing the prescription to the patient, this payment may be acquired in step 260 from an insurance associated with the patient. Finally, a variety of reporting may be provided to the covered entity in step 280, such as by way of example only, prescription activity, prescription inventory, account receivable activity and others.

Again, the sequence of steps depicted in the method of FIG. 3 may be altered without detracting from the present invention. In fact, the steps may occur in any order with no dependencies whatsoever.

The foregoing description of the preferred embodiment of the invention has been presented for purposes of illustration and description. It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, and variations that fall within the spirit and broad scope of the amended claims.

What is claimed is:

1. A method of providing pharmaceutical services, comprising the steps of:
receiving a pharmaceutical or ancillary device resulting from an order received on behalf of a covered entity for the benefit of a patient;
acquiring by a manufacturer or in connection with the manufacturer an accounts receivable of the patient from the covered entity wherein the accounts receivable is associated with the pharmaceutical or the ancillary device;
ensuring the pharmaceutical or the ancillary device is provided to the patient.

2. The method of claim 1, further comprising the steps of:
collecting a payment on behalf of the patient.

3. The method of claim 1, further comprising the steps of:
providing a fee to the covered entity for acquiring the accounts receivable.

4. The method of claim 1, further comprising the steps of:
providing a report to the covered entity associated with providing the pharamaceutical or the ancillary device.

5. The method of claim 1, further comprising the steps of:
providing a report to the covered entity associated with an activity of the accounts receivable.

6. The method of claim 1, further comprising steps of:
managing one or more prescriptions of the patient.

7. The method of claim 1, further comprising the steps of:
selling the accounts receivable back to the covered entity.

8. The method of claim 1, wherein the pharmaceutical or the ancillary device is associated with hemophilia.

9. A method of providing a patient prescriptions, comprising the steps of:
receiving an identification associated with a patient of a covered entity and a prescription of the patient;
ordering the prescription using a credit of the covered entity;
acquiring by a manufacturer or in connection with the manufacturer an accounts receivable from the covered entity associated with the patient; and
dispensing the ordered prescription to the patient.

10. The method of claim 9, further comprising the steps of:
acquiring a payment on behalf of the patient for the prescription.

11. The method of claim 9, further comprising the steps of:
providing a prescription consultation upon a request of the patient.

12. The method of claim 9, further comprising the steps of:
verifying an insurance coverage associated with the patient to pay for the prescription dispensed the patient.

13. The method of claim 9, further comprising the steps of:
providing a fee to the covered entity for acquiring the accounts receivable.

14. The method of claim 13, wherein the fee is less than an expense associated with the prescription.

15. The method of claim 9, wherein the prescription is associated with a treatment of a Hemophiliac.

16. The method of claim 9, wherein the prescription is dispensed to the patient at a patient defined location.

17. A method of transacting business with a covered entity, a pharmaceutical manufacturer and a patient comprising the steps of:
ordering a prescription from a pharmaceutical manufacturer on behalf of a covered entity wherein the prescription is for a patient of the covered entity;
acquiring by the manufacturer or in connection with the manufacturer from the covered entity an account associated with the ordering of the prescription and the patient; and
managing a delivery of the prescription to the patient.

18. The method of claim 17, further comprising the steps of:
collecting a payment from the patient for the delivery to offset a debit associated with the account.

19. The method of claim 17, further comprising the steps of:
collecting a payment from an insurance of the patient for the delivery to offset a debit associated with the account.

20. The method of claim 17, further comprising the steps of:
reporting an activity associated with the account to the covered entity.
